(19) United States
(12) Patent Application Publication
(10) Pub. No.: US 2002/0010620 A1
(43) Pub. Date: Jan. 24, 2002

(54) Targeted profitability system

(76) Inventors: Craig Kowalchuk, Aurora (CA); Sheldon Smith, Toronto (CA)

Correspondence Address: Mark D. Simpson, Esq., SYNNESTVEDT & LECHNER LLP, 2600 Aramark Tower, 1101 Market Street, Philadelphia, PA, 19107-2950, US

(21) Appl. No.: 09/804,448

(22) Filed: Mar. 12, 2001

Related U.S. Application Data
(63) Continuation-in-part of application No. 09/511,971, filed on Feb. 24, 2000.

(51) Int. Cl. G06F 17/60

(52) U.S. Cl. 705/10

(57) ABSTRACT

The invention provides a method or system for selecting a target group of most profitable consumers of a product or service from a group of consumers contained in a database. The invention involves selecting from the database a sub-group of consumers to whom a series of questions is posed. The invention then calculates a statistical relationship between the behavioral variables of each consumer and the variables contained in the database of the consumers. One then identifies variables contained in the database that are predictive of consumer profitability based on the strength of the statistical relationship. The invention then creates a mathematical algorithm that assigns a profitability score to each consumer. The invention then permits one to select from the database of scored consumers a target group of consumers that are most likely to be profitable targets for direct marketing.

### CROSS-REFERENCE TO RELATED APPLICATIONS

This is a continuation-in-part of pending U.S. application Ser. No. 09/511,971, filed Feb. 24, 2000.

### FIELD OF INVENTION

The present invention relates to a customised targeted marketing system to identify and locate individual profitable consumers for a given marketing objective. The system also relates to the adjustment of media audience rating scores that are provided by conventional rating methods.

### BACKGROUND

In view of increasing competition, service providers and suppliers of products have realised the importance of effectively targeting consumers for marketing. Previous targeting methods used historical information to determine what type of consumer had previously used product categories or brands. These factors were used to predict what consumers would likely purchase the brand or product category in the future. These methods targeted specific sub-sets of consumers based on the predictions.

Previous targeted marketing methods identified consumers based on category and volume of brand usage. Consumer targeting efforts were largely based on demographic and geodemographic factors. With demographics, the approach typically involved the administration of a survey to measure consumer usage levels pertaining to specific products, services and brands. These surveys also gathered general demographic information for each respondent. Standard analysis techniques were applied to study the results. Geodemographic systems were developed which categorized the entire marketplace of consumers in a specific number of neighbourhood types. The based neighbourhood types were classified according to demographic factors.

Targeting methods based on demographics and geodemographics have several drawbacks. Both methods assume that all consumers within a defined demographic or geodemographic sub-set are equally attractive. These methods do not discern between individual consumers. Demographic and geodemographic models also do not consider behavioural variables. Behavioural variables greatly influence the purchasing potential of consumers. Because of these drawbacks volume only oriented marketing techniques have yielded flat or decreasing returns.

There is therefore a need for a targeted marketing system that predicts profitable consumers more effectively. There is a further need for a targeted marketing system that targets individual profitable consumers. There is a need for such a system that links behavioural variables to other variables in order to identify individual profitable consumers.

The media buying and planning industry targets audience groups having the highest likelihood of profitability for a given advertiser. For example, television shows having high ratings among a group that is expected to be profitable would provide a desirable advertising medium. The target group could be for example 20 to 40 year old males for advertisers of beer. It would be expected that a football game would have high ratings for this target group. Conventional rating systems assign advertising media such as television shows rating points as a measure of the size of the audience that are attracted to the medium. These systems measure audiences in terms of criteria such as age, sex and demographic factors. These systems are often not effective for measuring consumer profitability because audiences are targeted according to very broad criteria that are often not a good indication of actual consumer profitability. This is problematic because advertisers seek to avoid paying for audiences that are projected to be less profitable. There is therefore a need for a system that provides a more accurate measure of the consumer profitability of an audience for an individual media property. There is a further need for such a system that can be used to adjust age and sex based rating points provided by conventional methods.

### SUMMARY OF THE INVENTION

The invention provides a system for selecting a target group of profitable individual consumers from a group of consumers contained in a database for a given brand or marketing objective. The database includes data variables for each consumer. The system links a profitability score of a sub-group of the group to the variables contained in the database for the sub-group. The profitability score is based on a calculation that includes both database variables and non-database variables. Based on a statistical analysis of this linkage, the system selects the individuals that are projected to be profitable on the database to target for marketing.

The invention also provides a method for selecting a target group of profitable individual consumers from a group of consumers contained in a database. The database includes data variables for each consumer. The method links a profitability score of a sub-group of the group to the variables contained in the database for the sub-group. The profitability score is based on a calculation that includes both database variables and non-database variables. Based on a statistical analysis of this linkage, the method selects the individuals that are projected to be profitable on the database to target for marketing.

The invention additionally provides a method and a system for adjusting audience ratings provided by conventional methods for a specific rating target group of consumers. This provides a refined measure of the audience's profitability. The rating group can be for example an audience of viewers of a specific age and sex whereas the individual media property can be for example a television show. The invention creates a profitability index based on a ratio between individuals who are projected to be profitable and a random selection of individuals. This index is applied to adjust a conventional audience rating based on the projected profitability of the audience for a target rating group.

The invention provides the advantage of effective return on investment for marketing efforts.

According to one aspect of the invention, there is provided a system for selecting a target group of most profitable consumers of a product or service from a group of consumers contained in a database. The database includes variables for each consumer. The system comprises the following elements:

means for selecting from said group, a sub-group of consumers;

means for gathering data from each member of the sub-group, the data including data relating to non-database variables of said members, the non-database variables being different than the variables contained in the database;

means for calculating a consumer profitability score for each member of the sub-group based on said data;

means for calculating a statistical relationship between the profitability score of members of the sub-group and the variables contained in said database of said members of the sub-group;

means for identifying variables contained in said database that are predictive of consumer profitability based on the strength of the statistical relationship between said variables contained in said database and said profitability score;

means for selecting from said group of consumers a target group of consumers having variables that are predictive of consumer profitability.

According to another aspect of the invention, there is provided method of selecting a target group of most profitable consumers of a product or service from a group of consumers contained in a database. The database includes variables for each consumer. The method comprises the following steps:

selecting from said group, a sub-group of consumers;

gathering data from each member of the sub-group, the data including data relating to non-database variables of said members, the non-database variables being different than the variables contained in the database;

calculating a profitability score for each member of the sub-group based on said data;

calculating a statistical relationship between the profitability score of members of the sub-group and the variables contained in said database of said members of the sub-group;

identifying variables contained in said database that are predictive of consumer profitability based on the strength of the statistical relationship between said variables contained in said database and said profitability score; and

selecting from said group of consumers a target group of consumers having variables contained in said database that are predictive of consumer profitability.

According to yet another aspect of the present invention there is provided a method for adjusting a rating score of a rating group of consumers for an individual media property, the method including the following steps:

providing a database including a group of consumers, the database including data variables for each consumer;

selecting from said group, a sub-group of consumers;

gathering data pertaining to each member of the sub-group, the data including data relating to non-database variables of said members, the non-database variables being different than the variables contained in the database;

calculating a profitability score in relation to a product or service for each member of the sub-group based on the data;

calculating a statistical relationship between the profitability score of members of the sub-group and the variables contained in said database of said members of the sub-group;

identifying variables contained in said database that are predictive of consumer profitability for the product or service based on a strength of the statistical relationship between said variables contained in said database and said profitability score;

selecting from said group of consumers a target group of consumers having the variables contained in said database that are predictive of consumer profitability for the product or service;

gathering data relating to a consumption of the individual media property from members of the target group;

creating a profitability index in relation to said individual media property based on the data relating to a consumption of an individual media property from members of the target group;

providing a rating group of individuals having a rating score for the individual media property based on conventional media rating methods; and

applying said profitability index to said rating group to provide a rating score of the rating group for the individual media property.

According to another aspect of the present invention there is provided a system for adjusting a rating score of a rating group of consumers for an individual media property, the system comprising:

a database including a group of consumers, the database including data variables for each consumer;

means for selecting from said group, a sub-group of consumers;

means for gathering data pertaining to each member of the sub-group, the data relating to non-database variables of said members, the non-database variables being different than the variables contained in the database;

means for calculating a profitability score in relation to a product or service for each member of the sub-group based on the data;

means for calculating a statistical relationship between the profitability score of members of the sub-group and the variables contained in said database of said members of the sub-group;

means for identifying variables contained in said database that are predictive of consumer profitability based on the strength of the statistical relationship between said variables contained in said database and said profitability score; and

means for selecting from said group of consumers a target group of consumers having the variables that are predictive of consumer profitability for the product or service;

means for gathering data relating to a consumption of the individual media property from members of the target group;

means for creating a profitability index in relation to said individual media property based on the data relating to the consumption of an individual media property from members of the target group;

means for applying said profitability index to a rating group of individuals having a rating score for the individual media property based on conventional media rating methods to provide a rating score of the rating group for the individual media property.

### DESCRIPTION

Overview of the Preferred Embodiment

Introduction

The objective of the present invention is to target for direct marketing or for highly refined mass marketing the most profitable individual consumers on a consumer database. The invention is a system or method that accomplishes this objective by identifying variables on the consumer database that are the most predictive of consumer profitability. The system performs a statistical analysis on a sub-group of consumers selected from the overall database to identify these predictive variables. The statistical analysis factors in behavioural variables. The system identifies the most profitable individuals in the overall database to target based on the predictive variables. The invention therefore provides an effective tool for directing marketing efforts to individual consumers on a database that have the highest probability of being profitable consumers of a particular product or service.

Consumer Databases

The collection of consumers on a consumer database is a group. A consumer database contains a plurality of data variables for each member of the group. Typically there are over 200 variables. This number can vary significantly. The variables can relate to many different types of data. The data can fall into categories including lifestyle, demographic, financial, home-ownership, vehicle registration and consumer purchase behaviour variables. A person skilled in the art will appreciate that one can include many different types of consumer data variables on a consumer database. In a preferred embodiment of the present invention, the database has lifestyle and demographic variables for over 85,000,000 individual consumers.

Selection of Sub-group of Consumers

To carry out the invention, a user randomly selects a sub-group of consumers from the overall group contained on the database. Preferably, the sub-group includes 20,000 people. The sub-group is randomly selected from the database using standard selection software that is well known in the art.

Alternatively, it is possible to pre-sort the group in order to select individuals having a pre-selected characteristic. For example, one may randomly select a sub-group of individuals in the group of males between 18-24 years of age. This may be appropriate for a particular type product such as disposal razors.

Development of Questionnaire

Preferably, a questionnaire is administered to each member of the sub-group. The questionnaire has questions directed to variables that are different from the database variables. Preferably these non-database variables are behavioural variables. Behavioural variables include purchase volume variables and variables including include brand loyalty, price sensitivity, brand choice, curiosity with respect to other brands and attraction to brand proposition. Based on answers to the questions, each member of the sub-group is assigned a profitability score that is an estimate of the member's profitability.

Purchase volume variables include variables relating to amounts actually purchased by a consumer within a product or service category. These variables also include variables relating to a consumer's intention to purchase a particular product or products within a product category. An overall estimate of purchase volume for each consumer factors in both of these types of variables.

One selects behavioural variables according to the marketing objective. These can be behavioural variables that a customer wishes to target. A person skilled in the art will appreciate that there are many behavioural variables from which to choose.

It is possible to obtain data relating to the non-database variables from other sources such as electronic databanks. In such a case it may not be necessary to administer a questionnaire to obtain the non-database variables.

Scoring of Questionnaire

The system assigns a consumer profitability score for each member of the sub-group based on answers to the questionnaire. Consumer profitability is a measure of the number of units that a consumer will buy in response to a targeted marketing program. A consumer with a high consumer profitability score is likely to buy a high volume of consumer items in response to a targeted marketing program. A person with a high profitability score is likely to purchase consumer items in a manner that yields a higher profit to manufacturers. These are the types of consumers that the system seeks to identify in the overall database.

The system first assigns a consumer profitability score for each member of the sub-group for purchase volume. The score for purchase volume includes the product of volume of units actually purchased within a category in a year and a profitability factor based on the volume of units that the member intends to purchase.

The system assigns a score for each answer relating to a behavioural variable. Answers to questions relating to behavioural variables indicate likelihood that the sub-group member will buy either more or less units. For example, a customer who has bought a high volume of the brand in question but has low brand loyalty is likely to buy fewer products based on the behavioural variable of low brand loyalty. Scores for behavioural variables are either positive or negative based on whether the variable predicts a higher or lower purchase volume of the brand. The score for each behaviour variable therefore either raises or lowers the overall score.

An overall score is then assigned to each member of the sub-group. The overall score includes the scores for purchase volume and behavioural questions. The system ranks the scores for each member of the sub-group from highest to lowest.

The questionnaire can either be scored manually or by computer using standard software known in the art.

Statistical Relationship Between Profitability Score and Database Variables

The system correlates the profitability scores of the members of the sub-group to their database variables. Based on a correlation analysis, the system calculates a statistical relationship between the profitability scores and the database variables. The statistical relationship takes into account the influence of the behavioural variables.

The statistical relationship can be calculated according to many different methods known in the art. A computer using standard software known in the art calculates the statistical relationship.

Identification of Database Variables that Predict Profitability

The system selects the database variables that are the most predictive of consumer profitability. The selection is based on the statistical relationship between the profitability scores of the sub-group members and their database variables. Preferably, the system identifies the 15-20 most predictive database variables.

Creating a Mathematical Algorithm

The selected predictive database variables do not necessarily have equal predictive weight. The statistical relationship discussed above determines the predictive weight of each selected predictive database variable. The system creates a mathematical algorithm that calculates a profitability score for each member of the database. The algorithm includes each of the selected predictive database variables as dependent variables. Multipliers for each variable reflect its predictive weight. The algorithm has the following formula:

Y=aX₁+bX₂+cX₃+dX₄+ . . . eXn

wherein,

Y is the profitability score;

X₁-Xn are scores for selected predictive database variables;

a-e are numeric multipliers; and

n is the number of selected predictive database variables.

The mathematical algorithm is created using standard computer software known in the art. Many methods known in the art can be used to create a suitable mathematical algorithm.

Calculating Profitability Score for Each Group Member

The system calculates a profitability score for each member of the group on the database according to the mathematical algorithm. The calculation is carried out with computer software known in the art. Each member of the group is ranked from highest to lowest according to their profitability score.

Selecting a Target Group

A top portion of the profitability ranked group is selected as a target group for direct marketing. These individuals are contacted directly. Preferably, the group members falling in the top 15% of profitability scores are selected. The selection is carried out using standard selection software known in the art.

Detailed Description of the Preferred Embodiment

Database

The preferred embodiment employs a database of 85,000,000 individuals residing at specified addresses. The database includes lifestyle and demographic variables.

Selection of Sub-group

A collection of 20,000 names is randomly selected from the database. A sub-group of 1,500 to 2,000 members of the smaller group are expected to complete a questionnaire.

Pre-sorting

Preferably, prior to the random selection of 20,000 individuals with phone numbers that are used as the base of potential survey respondents, a pre-sorting or pre-screening function is performed. The purpose of pre-sorting is to reduce the range of consumers on the national database to which the profitability scoring system will be developed and applied. The goal in reducing the range of consumers is to eliminate consumers (prior to the implementation of the system) that have a significantly lower probability of achieving a strong economic value than the average consumer based on their below average purchase rate in the category.

In order to determine whether it is advisable to eliminate certain sub-sets of consumers from the system, a simple analysis of current category usage by each demographic sub-set is generated using one of several industry sources for this type of analysis, such as that of AC Nielsen. The distribution of sales volume (units purchased in past 12 months) across each demographic sub-set is compared to the natural household distribution of the same sub-sets. An index is created for each demographic sub-set to determine its relative over or under sales development rate or purchase volume rate by dividing the % distribution of units into the % distribution of the population for each demographic sub-set.

If the analysis indicates that women above the age of 65 index significantly below 100 (which is the average) for current sales development for category X, than these consumers would be eliminated from the national database list prior to the random selection of names to be used as the base of potential survey respondents. Indexes below 65 are used as thresholds for eliminating demographic sub-sets.

The national database is sorted based on the occurrence of the non-desirable demographic sub-set to isolate undesirable prospects. These consumers are then eliminated from the database and the rest of the process.

Preparation of Questionnaire

A questionnaire is developed that assesses consumer response to questions representing a range of behavioural variables. The objective is to obtain information relating to behavioural variables for a product or service. A series of questions seeks information pertaining to each variable. There are 20-30 questions per survey.

There is a standard pool of about 100 questions that are used to obtain behavioural information from questionnaire respondents. A person skilled in the art can select the questions pertaining to each variable and generate additional questions as needed.

The questionnaire employs a significant number of questions relating to the consumer's attitudes. Questions relating to behavioural attitudes include questions relating to brand orientation, brand loyalty, purchase history of certain goods or services and whether a coupon or sample would facilitate purchase of a good or service.

The questionnaire is administered by telephone, or by internet, mail or in the form of in-person surveys. The order in which the questions are put to respondents is rotated randomly in order to prevent bias.

Scoring of Questionnaire

(i) Preliminary Editing of Data

Once the survey data has been recorded for each respondent, it is transferred to a central database containing respondent data from other respondents. At the completion of the study and before the data is used for scoring purposes, the data is cleaned and edited to ensure maximum accuracy and reliability. The following steps are performed on the data:

a. Identify and remove records that have incomplete data

b. Identify and remove records where an invalid code has been entered by the questionnaire administrator

c. Identify and remove records where exaggerated responses have been provided by the respondent (i.e. the respondent may have identified that they purchase 4,000 units of a given brand or service per year)

d. Identify and remove records where there are inconsistencies between responses to specific questions by the same respondent (i.e. the consumer indicates that they never use the product category in one question yet records a number of units purchased of the product category in another question later on in the survey)

(ii) Calculation of Sales Potential

In order to effectively calculate the economic, or sales, potential of a particular brand-oriented marketing strategy, it is necessary to consider the historical volume or purchase within the particular category of products or services purchased and the consumer's expressed intent to purchase the product being targeted. These two variables are particularly important to the current system because they estimate the total potential number of units that a consumer could buy of the product or service in a given time period.

The basis used to calculate the sales potential is the volume purchased. This value is subsequently modified by an expressed intent to purchase the particular product or service within the category. The total number of units that the consumer purchases in a category in a given period (sales potential), when combined with an intention to purchase predicts the total sales volume for the given product.

The system assumes that an estimate of the sales potential of a household or individual can be obtained from the mathematical product of the likelihood that a consumer will buy a product or service and the volume of sales within the same category. This is achieved by annualising the number of purchases that a consumer makes in a given category, then multiplying, or factoring, the number of annual purchases by their expressed intention to purchase the product or service.

The average sales potential per consumer for the entire database is determined next. The results are sorted and ranked, and the top 10% isolated. Standard mathematical and statistical assumptions are made that the population isolated using this procedure is representative of the population of consumers that is in fact responsible for the most significant amount of volume purchases of the product or service at issue.

The average sales potential per customer is then divided by the average sales potential for the entire database to create a normative index, which provides a quantitative reference point to calculate the effect on sales potential when further variables or questions are added to the analytic procedure. This step is important, as it serves to test the model internally to ensure maximal predictive value.

Effect of Scoring Index on Sales Potential

The effect of each behavioural variable on sales potential for that consumer is then determined. For example, the effect on base sales potential is determined by successively adding behavioural variables such as coupon usage, and tendency to brand switch. The resulting cumulative value will increase, decrease, or remain neutral depending on the effect of each combination on behavioural variables.

In each scenario, the top 10% of households are ranked. The sales potential for the top 10% is compared and indexed to the sales potential for the entire survey base. Using this methodology it is possible to compare the degree to which the mean sales potential falls or increases (when compared to the average for the whole base) when new behavioural variables are added to the model. Behavioural variables that decrease the efficiency of the model are not factored into the statistical analysis.

Once the optimal behavioural variables have been selected, the system then applies these variables to create a profitability score for each member of the sub-group.

Relationship Between Profitability, Demographic & Lifestyle Variables

The objective of the next stage of the analytical system is to statistically measure the relationship between each survey respondent's profitability score and their self-reported demographic and lifestyle characteristics. This information is obtained from the database. Once the relationship between profitability and lifestyle demographic characteristics is measured, independent variables are identified that correlate strongly with the score. The final step is to build a mathematical algorithm that predicts the profitability potential for every consumer on the national database using the optimal set of independent demographic and lifestyle behavioural variables.

(i) Matching Survey Respondents

The first stage of the modelling procedure is to match survey respondents back to the database. A software program developed specifically for this procedure is applied to match survey respondents to their original record using identifiers such as name, address, and telephone numbers.

(ii) Collinearity Analysis of Independent Variables

Once matched the demographic and lifestyle behavioural data from the database is appended to the survey respondent record which includes the generated profitability score from the previous step. Standard industry software is used to analyse the data.

Approximately 200 independent variables are tested against the profitability score. Preferably, several stages of analysis are performed, with the intent of decreasing the number of possible independent variables used to create the final predictive algorithm. This procedure is used in order to ensure that the final model is mathematically and statistically robust and accurate in its predictive output.

Collinearity is checked at several stages of the model process to observe the interrelationship between independent variables and to ensure efficient operation of the model. Independent variables that are highly correlated to one another result in inefficient operation of the model and need to be minimized or removed altogether. Typically independent variables having a collinearity measure of ≧0.6 are eliminated. The independent variable having the highest incidence rate on the survey respondents database is retained and the lower incidence variable is dropped. The average reduction in the number of independent variables using this method is, approximately 15%, or from 200 at the start of the procedure to approximately 175.

(iii) Single Level Chaid Analysis

The approximately 175 independent variables are carried forward to the next stage of the system, which comprises a Single Level Chaid analysis. The purpose of this type of analysis is to determine the statistical significance of the differences observed in the strength of the relationship between the remaining independent variables and the dependent variable, which in this case is the profitability score. The measurement used as the discriminator is represented by a conventional P value, or probability score, where the P value represents the probability that the strength of the relationship between the dependent and independent variables is significant.

In the present system, the Single Chaid analysis is also used to collapse some of the categorical independent variables together, where the probability of the difference observed for each individual variable is not significant on its own. In certain circumstances, a single aggregate variable can be created by the model where there is little or no probability of statistical difference between those particular variables. The purpose of this stage of the analytic system is to eliminate demographic and lifestyle variables that have a poor statistical relation to the profitability potential score.

The Single Chaid analysis typically retains approximately 35-40% of the original 200 as independent variables that are determined to be the most predictive of the economic score i.e. the dependent variable. A subsequent correlation analysis is run to measure the collinearity of the remaining independent variables. There are some instances where either the analysis objectives or empirical research done by a given packaged goods manufacturer or service provider suggest the involvement of certain demographic or lifestyle considerations that correspond to independent variables eliminated by the Chaid analysis. However, only where the statistical strength of the model is increased are any of the remaining independent variables inserted back into the model.

(iv) Linear Regression and Algorithms

The final step in the predictive model is to generate an appropriate algorithm. This algorithm is created based on the results of the previous steps in the system. The stepwise linear regression technique used determines the relative importance of each remaining independent variable, rank orders them, measures the incremental effect or value of each variable in explaining the variance, and finally determines the significance of the variance measurement for each of the independent variables within a pre-determined significance level.

The output from the analysis is given in the form of an r² score, which measures the cumulative fit of all variables when included and interacting together in the final algorithm. Typically between 15 and 20 variables are included to create the final algorithm. Generally, the higher the r² score, the higher the positive or negative predictive value of the model of the profitability score. The r² numerical value represents the percentage of a given consumer's profitability score that can be explained by the 15-20 variables that are included in the final algorithm.

Once the final algorithm has been generated, the model is applied to the national database. The output algorithm includes a variable co-efficient for each variable in the model. A profitability score is generated for each individual survey respondent by applying the individual variable coefficients to the data value for each individual lifestyle and behavioural variable in the model. The algorithm has the following formula:

Y=aX₁+bX₂+cX₃+dX₄+ . . . eXn

wherein,

Y is the profitability score;

X₁-Xn are scores for selected predictive database variables;

a-e are numeric multipliers; and

n is the number of selected predictive database variables.

The system calculates a profitability score for each member of the group on the database based on the algorithm. The members of the group are ranked according to their profitability scores. Preferably, the group members falling in the top 15% of profitability scores are selected for direct marketing.

Alternate Embodiments

Geodemographic Block Groups

In this embodiment, the results of the ranking and indexing steps are used to perform a geographic based analysis, in which neighbourhoods of profitable consumers are identified using either the mean score per neighbourhood or the density of profitable consumers in a given area obtained from the national database.

If the client is executing a neighbourhood level block group targeted direct to home distribution, the profitability analysis system is subject to additional steps. This applies to the use of neighbourhood level/enumeration area targeted programs in the U.S. and Canada.

First, block group codes are appended to each individual consumer record on the economically scored national database list. This is achieved by using a standard government conversion file and matching the corresponding block group code to each individual consumer record based on the full street address and market of the individual. Block groups generally have an average of 300-400 households. Once appended, consumers on the list are sorted based on their block group code. Because the database does not have an accurate measure of exactly how many total households there are in each block group and therefore, what percent of total households they have on their file, the system sets a minimum threshold household count before proceeding to the next stage of analysis. At this point, a count is made of how many households the database lifestyle selector file has for each block group. Block groups that have fewer than 10 records are eliminated because of concerns about data stability and reliability.

With the remaining records, a total score value is generated for each block group by aggregating the individual households economic score values for households in the block group. This value is then divided by the number of households in the block group to create an average household score for the block group. Block groups are then ranked from high to low based on the score. Block groups are then selected from the top of the list as in the case of a direct mail.

Telephone Interview Follow-ups

In another embodiment, the group of consumers identified by the ranking step in the sample population are contacted by telephone for the purpose of confirming the results of the modelling and ranking analyses, and to determine whether or not the variables used in the modelling stage were optimal. If not, the information obtained makes it possible to adjust the factoring of individual scores so as to optimise the r² values in the model.

Media Profitability Modelling

In addition to its applications for direct mail and neighbourhood direct to home distribution, the targeted profitability system can be applied to enhance the targeting of consumers that have a projected higher economic value through the use of more traditional mass media.

The output from the targeted profitability system audience analysis system are a set of indices that identify the relative over or underdevelopment of the highest economically valued consumers from the targeted profitability system scored household file within the audience base of specific media, TV programs, radio formats and time blocks, magazines, etc. For example, an index of 150 for Magazine A, would mean that the highest economically scored households are 50% more likely to read Magazine A than the average consumer on the list.

The first step is to develop the media usage questionnaire. The targeted profitability system media usage questionnaire is preferably designed to be administered using either a telephone survey method or by internet. The questionnaire is designed to not only measure whether the respondent watched, read or listened to a specific media property, but also to try and gauge how long the respondent spent with the property and how many times in the last 4 weeks they were engaged themselves in the same property. For example, a respondent who read Magazine A once in the last four weeks for 15 minutes is given less value (in the development of the audience index) than a respondent who read four out of the last four issues and spend an hour each time. The survey measures usage of a media property within the past week (any usage), how much usage within the last week (how long) and how many times in the previous four weeks (frequency).

Application TOPS™ Media

Once a target group of consumers who are projected to be profitable from the database is identified, this target group is preferably filtered to remove individuals who are not actually profitable consumers for the product or service in question. The filtering process can be carried out through the administration of a questionnaire. The questionnaire is normally administered by telephone to gather data pertaining to the same non database variables that are used originally to estimate a consumer's profitability score from the database sub-group. These non database variables are used to determine the respondent's actual profitability. Respondents that do not achieve a minimum profitability score are filtered out. The process preferably ends when 5,000 profitable consumers are identified.

Once actual profitable consumers are identified, then these consumers are administered a questionnaire in order to determine their media consumption habits. The questions can relate to many different behavioural factors including, consumer services consumption habits, television watching habits, movie watching habits, radio listening habits, internet browsing habits, magazine reading habits, newspaper reading habits, sporting event watching habits, music concert event watching habits, billboard reading habits, travel habits, catalogue reading habits, advertising flyer reading habits, commuting behaviour and physical fitness habits. Based on the answers to the questions, a profitability index is created for an individual media property.

An individual media property is any medium that is watched by consumers. An individual media property includes the following: a television show, a radio show, a movie, a website, a magazine, a newspaper, a sporting event, a music concert, a billboard, a catalogue, an advertising flyer.

By comparing the media consumption behaviour of profitable consumers to randomly selected consumers both drawn from a rating target group, the system generates a profitability index. For example, the media consumption measure could indicate that 12% of profitable consumers within the female 25-54 age range watch an individual media property, which is television show A, every week. The measure could indicate that 10% of randomly selected females in the 25-54 age range watch television show A every week. By dividing 12% into 10%, the system generates a profitability index of 120 for television show A. This indicates that 20% more of the 25-54 female audience for television show A are profitable than would be calculated by conventional methods. The rating score generated by conventional methods could then be adjusted to show an increase of 20%.

The index is therefore applied to a conventional measure of the profitability of an audience. Based on the application of the index, the actual profitability of the audience is adjusted upwardly or downwardly.

### EXAMPLES

### Example 1

Targeted Advertising Profitability Projection

The performance and financial impact of the targeted profitability-based marketing system is projected and compared theoretically with a conventional volume-based geodemographic marketing system. The return on investment yielded by the two marketing systems was compared from the perspective of a packaged goods manufacturer or service provider. The unit product is denoted “Brand X”, which in this case is a unit of laundry detergent. The comparison assumes that an identical targeted direct ad program was administered using the most profitable consumers selected by both systems.

Projection Target: Laundry Detergent:

(i) Heavy powdered laundry detergent users (volume)

(ii) Consumers interested purchasing a new version of Brand X with an additive to kill 99.9% of bacteria that cause odours (intent to purchase)

(iii) Consumers less likely to only buy Brand X with the additive, when on sale (less price sensitive)

Objective:

To compare the projected economic return of the same consumer brand advertising program when targeted to individual households using a demographic based targeting and the profitability targeting system

Assumptions:

The assumptions made for the projection were as follows:

(i) Advertising program would be delivered to individuals by US Mail.

(ii) Brand X advertising to be sent to 2,000,000 households within the Mid-Atlantic, South East and South Central market regions.

(iii) Women 25-54 with children were chosen as the demo graphic targeting criteria.

(iv) Client profit margin on a box of detergent would be 35% of purchase price.

(v) Direct mail advertising production and distribution costs for reach a targeted household would be the same for both targeting methodologies (35 cents/consumer).

(vi) The cost of applying a demographic targeted list would be 5 cents per consumer name.

(vii) The cost of applying a profitability targeted system targeted list would be 11.5 cents per consumer name.

TABLE 1
Comparison of Profitability System to Geodemographic
system for Targeted Advertising Profitability Projection

| | Profitability | |
|---|---|---|
| Projections | System | Geodemography |
| A) Household coverage | 2,000,000 | 2,000,000 |
| B) Incidence rate for finding heavy | 40% | 20% |
| powdered detergent users within target | | |
| list. | | |
| C) Targeted heavy users = A) × B) | 800,000 | 400,000 |
| D) Success rate at converting targeted | 20% | 15% |
| prospects to purchase the product at | | |
| least once. | | |
| E) Converted heavy user consumers - | 160,000 | 60,000 |
| C) × D) | | |
| F) Projected number of annual | 10 | 8 |
| Purchases for Brand X once a | | |
| Consumer prospect has converted | | |
| G) Mean purchase price paid per box | $5.75 | $5.50 |
| for converted consumers | | |
| H) Customer Value - year 1 = F) × G) | $57.75 | $44.00 |
| I) Projected Revenue - year 1 = H) × | $9,240,000 | $2,640,000 |
| E) | | |
| J) Projected Profit Margin | $3,234,000 | $924,000 |
| K) Production and distribution costs to | $700,000 | $700,000 |
| send targeted print advertising to | | |
| 2,000,000 households | | |
| L) Targeted list costs for 2,000,000 | $230,000 | $100,000 |
| names | | |
| M) Net Program Profit = J) − K) − L) | $2,304,000 | $124,000 |

Implication: The targeted profitability is projected to yield 2.18 Million dollars worth of incremental profit when compared to the application of the geodemographic targeting system.

### Example 2

Targeted Advertising Profitability Measurement

The actual performance of the targeted profitability-based marketing system was compared with that of conventional volume-based geodemographical marketing. The unit product is denoted As with the projection described in Example A, “Brand X” is a unit of laundry detergent.

The objective of the example was to compare the actual economic return of the same consumer brand advertising and coupon incentive program when targeted to individual households using a demographic based targeting and the targeted profitability system targeting system.

The targets for the comparison were as follows:

(i) Heavy laundry detergent users

(ii) Powdered detergent users

(iii) Consumers interested purchasing a new version of Brand X with an additive to kill 99.9% of bacteria that cause odours

Program Specifics:

(i) Advertising program with 50 cent coupon delivered to individuals by US Mail.

(ii) Brand X advertising was to be sent to 1,400,000 profitability targeted households within the Mid-Atlantic, South East and South Central market regions.

(iii) 50,000 demographically targeted household were mailed as a test group.

(iv) 50,000 demographically targeted households were held back from the mailing as a control group.

(v) Women 25-54 with children would be the demographic targeting criteria.

(vi) Two months after the program was executed the quantitative difference in list targeting quality and consumer behavioural reaction to the program would be measured.

(vii) Client profit margin on a box of detergent would be 35% of purchase price.

(viii) Direct mail advertising production and distribution costs for reach a targeted household would be the same for both targeting methodologies (35 cents/consumer).

(ix) The cost of applying a demographic targeted list would be 5 cents per consumer name.

(x) The cost of applying a profitability targeted list would be 11.5 cents per consumer name.

(xi) Retail price for the product would be $5.50 per unit.

Research/Methodology:

The objective of the post-projection research trial was twofold. First, the research was designed to measure the success of the two test lists in finding consumers more likely to be heavy laundry consumers who use powdered detergent and who are very interested in a version of Brand X that kills odour causing bacteria. Second, to understand what percentage of targeted consumers actually converted into real consumers for the product after having been targeted.

The research was conducted approximately 8 weeks after the direct advertising program was delivered to targeted households and was conducted against three cells:

(i) Control: Random list of demographically targeted households that did not receive the advertising and coupon program

(ii) Test 1: Random list of demographically targeted households that did receive the advertising and coupon program

(iii) Test 2: Random list of profitability targeted households that did receive the advertising and coupon program

The research was conducted via telephone and was designed to achieve approximately 200 respondents per cell. Information was collected on: (1) the average number of loads of laundry per week that are washed by each respondent household; (2) what percent of consumers were “powder only” or “mostly powder” detergent users; and (3) what percent of consumers targeted had bought Brand X in the last 3 months.

Based on actual data gathered from the in-field study, the projected economic performance of the two targeting lists was compared over a twelve-month period.

Results for the 50,000 demographically targeted households were subsequently extrapolated to a comparable 1,400,000 household drop based on the data generated by the research. The results were as follows:

TABLE 2
Comparison of Profitability System to Geodemographic
system for Targeted Advertising Profitability Measurement

| | Profitability | |
|---|---|---|
| Projections | System | Geodemography |
| A) Household coverage: | 1,400,000 | 1,400,000 |
| B) Incidence rate for finding heavy | 58% | 31% |
| powdered detergent users within | | |
| target list | | |
| C) Targeted heavy users - A) × B) | 812,000 | 434,000 |
| D) Success rate at converting targeted | 24.1% | 16.1% |
| prospects to purchase the product at | | |
| least once | | |
| E) Converted heavy user consumers = | 195,700 | 69,900 |
| C) × D) | | |
| F) Projected number of annual | 9.5 | 9.2 |
| purchases for Brand X once a | | |
| consumer prospect has converted | | |
| based on their average loads per week | | |
| G) Mean purchase price paid per box | $5.50 | $5.50 |
| for converted consumers | | |
| H) Customer value - year 1 = F) × G) | $52.25 | $50.60 |
| I) Projected Revenue - year 1 = H0 × | $10,223,325 | $3,536,940 |
| E) | | |
| J) Projected profit margin = I) × 35% | $3,578.163 | $1,237,929 |
| K) Production and distribution costs | $700,000 | $700,000 |
| to send targeted print advertising to | | |
| 2,000,000 households | | |
| L) Targeted list costs for 2,000,000 | $350,000 | $150,000 |
| names | | |
| M) Net Program Profit = J) − K) − L) | $2,528,163 | $387,929 |

Implication: The targeted profitability system yielded a projected profit that was 6.5 times higher than the profit yielded by geodemographic system

### Example 3

Questionnaire Development and Scoring

(i) Questionnaire Development:

The following is an example of a survey administered by telephone.

Good evening, My name ______ is of research company X. We are conducting a survey of people's grocery purchase behaviour. I would like to ask you a few questions if I could.

1. Are you the primary individual in your household who does the grocery shopping? (if no, ask for shopper or else end the interview)

2 I would like to ask you a few questions about laundry. How many loads of laundry are typically done in your household in an average week?

# of loads per week ______

Don't know ______

3 In the past 12 months, have you yourself bought any laundry detergent for your household?

Yes continue

No ask to speak to person who has

4 In past 12 months, how many boxes or containers of laundry detergent have been bought for your household?

# of boxes or containers ______

Don't know ______

5 Approximately what percentage of these laundry detergent purchases would have been made with a coupon?

% of purchases with coupon ______

Don't know ______

6 When it comes to buying laundry detergent, which one of the following statements, best describes your household?

We always buy powdered detergent

We mostly buy powdered detergent

We buy powdered and liquid detergent about the same

We always buy liquid detergent

We mostly buy liquid detergent

7. Using a scale of 1 to 5 with 1 representing strongly disagree and 5 representing strongly agree, how strongly would you say you agree or disagree with the following statements.

I don't consider laundry clean unless I am confident that all the germs and bacteria have been killed—level of agreement ______

I always buy the same brand of laundry detergent—level of agreement ______

I like to try new products that I think will do a better job at cleaning my clothes—level of agreement ______

I always load up on my favourite brand of laundry detergent when it goes on sale Level of agreement ______

I would likely try a new detergent if I thought that it would do a better job at killing germs and bacteria in the wash—level of agreement ______

8. In the past 12 months, how many boxes or containers of laundry detergent have you bought for each of the following brands (rotate list)?

Brand A number of boxes or containers ______

Brand B number of boxes or containers ______

Brand C number of boxes or containers ______

Brand D number of boxes or containers ______

Brand E number of boxes or containers ______

Brand F number of boxes or containers ______

Brand G number of boxes or containers ______

Other number of boxes or containers ______

9. In the next few weeks, Brand X is launching a new product that has a new additive that has been proven to kill 99.9% of the bacteria in clothes and laundry that cause odours. Once this product becomes available in your local store, how likely are you to purchase this product?

Very likely ______

Somewhat likely ______

Somewhat unlikely ______

Very unlikely ______

Questionnaire Scoring:

Once individual consumer response data has been gathered and edited, the data is used to estimate an economic value or value for each survey respondent. Scoring or valuing each respondent can only happen once the determination is made as to which specific questions and question responses will be used as the data source to derive the economic value. These determinations are known to those skilled in the art.

The objective in the scoring process is to estimate (in a relative sense) the number of units (based on number of loads of laundry) of the specific brand's products each individual consumer could realistically purchase in a 12 month period.

### Example

Brand X Laundry Detergent

Assumptions:

(i) A new line of Brand X powdered laundry detergent would be launched. The detergent has a new additive that has been proven to kill 99.9% of the bacteria that causes odours in clothes.

(ii) A piece of brand Brand X advertising and a 50 cent coupon for Brand X would be sent to households targeted through this program.

(iii) Brand X would be only available in a powdered format.

Scoring approach for Brand X program:

(i) First step would be to take the number of loads of laundry per week value that each respondent provided based on the question: “I would like to ask you a few questions about laundry. How many loads of laundry are typically done in your household in an average week?”

This represents the basis from which to being estimating each consumer's volume potential.

(ii) Second step would be to multiply the number of loads by a factor to help reflect the relative interest that each consumer would have in a powder only brand. The result would not be an absolute value but rather would be a relative value derived by multiplying units times a probability based on the question:

“When it comes to buying laundry detergent, which one of the following statements, best describes your household?”

The assigned probability values would be:

We always buy powdered detergent 2.0

We mostly buy powdered detergent 1.7

We buy powdered and liquid detergent about the same 1.5

We mostly buy liquid detergent 1.25

We always buy liquid detergent 1.0

The probability factors assume that someone who only uses powdered detergent would typically be twice as likely to be interested in another powdered detergent than someone who never uses powder.

Scoring:

| | Loads | Powder Factor | New value |
|---|---|---|---|
| Respondent 1 | 20 | 2.0 | 40 |
| Respondent 2 | 6 | 1.5 | 9 |
| Respondent X | 10 | 1.0 | 10 |

(iii) The next step would factor each consumer again by the probability of their expressed likelihood to purchase the product based on the attributes and brand benefits proposed to the consumer in the question:

“In the next few weeks, Brand X is launching a new product that has a new additive that has been proven to kill 99.9% of the bacteria in clothes and laundry that cause odours. Once this product becomes available in your local store, how likely are you to purchase this product?”

Very likely ______

Somewhat likely ______

Somewhat unlikely ______

Very unlikely ______

Assigned probability values:

Very likely 2.0

Somewhat likely 1.7

Somewhat unlikely 1.25

Very unlikely 1.0

The probability factors assume that consumers that express an intent to purchase a product are relatively twice as likely to do so as consumers that express that they are very unlikely to so.

| | | | Purchase | |
|---|---|---|---|---|
| Scoring: | Loads | Powder Factor | Intent | New value |
| Respondent 1 | 20 | 2.0 | 1.25 | 50 |
| Respondent 2 | 6 | 1.5 | 2.0 | 18 |
| Respondent X | 10 | 1.0 | 1.7 | 17 |

(iv) The next step would be to multiply each consumer by the relative probability that they will be additionally motivated to try new Brand X by the coupon based on responses to the following question:

“Approximately what percentage of these laundry detergent purchases would have been made with a coupon ?”

Based on this question, anyone who answers with a value greater that 1% is treated as a coupon redeemer for the category. Their relative probability of purchasing the product would be enhanced by the delivery of the coupon. This is now factored into the economic value.

Assigned probability values

Coupon usage greater than 1% 1.25

Coupon usage is zero 1.0

The probability factors assume that consumers that use coupons in a category would be approximately 25% more likely to buy another product in the category if they are offered a coupon.

| | | | Purchase | Coupon | New |
|---|---|---|---|---|---|
| Scoring: | Loads | Powder Factor | Intent | Factor | Value |
| Respondent 1 | 20 | 2.0 | 1.25 | 1.25 | 62.5 |
| Respondent 2 | 6 | 1.5 | 2.0 | 1.25 | 22.5 |
| Respondent X | 10 | 1.0 | 1.7 | 1.0 | 17 |

(v) This last calculation of new value would be used as the final estimated consumer economic value or profitability value. This value would then be carried directly into the next step where these values would be correlated to the lifestyle and demographic characteristics for each individual.

### Example 3

### Media Modelling

The questionnaire measured media usage differential between consumers that are ranked in the top 15% of most profitable consumers and a group of average consumers randomly selected throughout the database based on the given media properties as follows:

(i) TV:

(a) by usage quintile

(b) by program—major network properties and major syndicated programs

(c) by cable service/specialty channel—including some specific programs

(d) by sport

Radio:

(a) by usage quintile

(b) By format

(c) By timeblock

(ii) Magazine

(a) by usage quintile

(b) By title

(iii) Newspaper

(a) by usage quintile

(b) By section

(c) By major national papers—i.e. USA Today

(iv) Internet

(a) by usage quintile

(b) By types of sites visited

(v) Events

(a) Attendances/participation in activities or events

(b) Sports, Arts, Movies, Clubs, Attractions/theme parks.

The survey was designed to be administered in approximately 20 minutes. Questions were rotated in a way so as not to develop systematic response biases and missing data as a result of respondent fatigue.

Potential survey respondents were randomly selected from the scored national database list of names (of consumers who have telephone numbers recorded on the file) for two groups:

1) Consumers whose economic score when ranked, places them amongst the top 15% of scored individuals on the total file of scored individuals

2) A group of consumers representative of a cross section of the total list. These consumers were randomly selected from throughout the total list

Before selecting names for the two individual groups several steps occurred. Scored individuals with phone numbers were identified. From amongst these records only, a further identification was made of the age and sex of the target consumers desired for the survey. If the “traditional” media target for Brand X was “Women between the ages of 25-54 years old”, and then only these records were selected. All female 25-54 year olds with phone numbers were then written to a new file and ranked. Every nth record of consumers identified from the top 15% of the original scored file were chosen to form the pool of potential respondents for this group. Starting with the second record, every nth (×6.7) record was selected from throughout the entire file. This group is the group representative of the cross section of the entire list and is used as the second pool of potential respondents. N varied based on the total number of required completed interviews for the two groups. The same questionnaire is then administered against both groups.

### Example 4

### Beer Consumption Profitability of Audience for Football Audience

Traditional audience measurement services generate audience projections for different media properties based on standard age and sex defined target groups. The following is a hypothetical example of how the reported audience statistics may look for an individual media property which in this example is a TV broadcast of a football game in a single market city:

| Age and Sex based Target Group | Average Rating |
|---|---|
| Total Adults 18+ | 6 |
| Total Adults 18-24 | 7 |
| Total Adults 18-34 | 7 |
| Total Adults 18-49 | 6 |
| Total Adults 50+ | 5 |
| Total Women 18+ | 2 |
| Total Women 18-24 | 3 |
| Total Women 18-34 | 3 |
| Total Women 18-49 | 2 |
| Total Women 50+ | 1 |
| Total Men 18+ | 10 |
| Total Men 18-24 | 11 |
| Total Men 18-34 | 11 |
| Total Men 18-49 | 10 |
| Total Men 50+ | 10 |

A rating point represents an average measure the percentage of the age and sex sub-group population that watch a particular TV program. If the station in the market city charges a brewery advertiser $10,000 for each 30 second commercial to advertise on the football game, and if the brewery is targeting men 18-24 as their primary target audience for a brand, then a standardized economic valuing is calculated for the program. An industry standard “Cost Per Rating Point” efficiency calculation is generated by dividing the cost of the commercial spot into the rating points delivered for the brewery's target group.

Dividing $10,000 into an 11 rating yields a cost per rating point of $909. This could then be compared to cost per point of other programs to help isolate programs that are more cost efficient than others for the brewery advertiser.

The application of the present invention refines the reported rating by adjusting it based on refined definition of the target consumer. In this example, when using conventional reported ratings, the assumption is that all 18-24 year old men delivered in the audience of a particular program are of equal value to the brewery. It assumes that the brewery is interested in speaking to all 18-24 year old men and that this is their target group. This is not necessarily the case. All 18-24 year old men do not represent the same profit potential for a beer brand. Some 18-24 year old men don't drink beer at all or are light drinkers. Others are heavy drinkers and will be less likely to switch brands. The real target group for the brewery might be better described as, 18-24 year old men who are heavier beer drinkers who are more likely to use or be attracted to their particular brand and proposition. These consumers would represent a much higher profit potential for the brand if they could be targeted. The application of the present invention in this example enables users to readjust the audience rating based on the relative concentration of more profitable 18-24 year old men. The present invention creates an index that acts like a filter to revalue media property audiences (for any media) based on relative concentration of profitable consumers.

For example, for this particular beer brand, the present invention may generate an index for the football game of 125. This would indicate that the relative concentration of profitable men 18-24 for the beer brand in this program is about one and a quarter of what it is within the male 18-24 population on average. This index can now be applied directly to the reported male 18-24 rating for the football game to generate a rating point measure for the profitable sub-group.

| | | TOPS ™ Media | |
|---|---|---|---|
| Program | Rating | Profitability Index | Adjusted Rating |
| Football Game | 11 | 125 | 13.75 |

This new measure which estimates a rating for the most profitable sub-group of men within the 18-24 year old group can now be reapplied to the cost of a 30 second commercial to re-value the cost efficiency of the program. Dividing $10,000 into the audience delivery of an 13.75 rating for profitable men 18-24 changes the cost per point measure from $990 per point to $727.27 per point.

A person skilled in the art will appreciate that although specific embodiments have been described, the invention is not to be limited to the specific embodiments described herein.

1. A method for adjusting a rating score of a rating group of consumers for an individual media property, the method including the following steps:
providing a database including a group of consumers, the database including data variables for each consumer;
selecting from said group, a sub-group of consumers;
gathering data pertaining to each member of the sub-group, the data including data relating to non-database variables of said members, the non-database variables being different than the variables contained in the database;
calculating a profitability score in relation to a product or service for each member of the sub-group based on the data;
calculating a statistical relationship between the profitability score of members of the sub-group and the variables contained in said database of said members of the sub-group;
identifying variables contained in said database that are predictive of consumer profitability for the product or service based on a strength of the statistical relationship between said variables contained in said database and said profitability score;
selecting from said group of consumers a target group of consumers having the variables contained in said database that are predictive of consumer profitability for the product or service;
gathering data relating to a consumption of the individual media property from members of the target group;
creating a profitability index in relation to said individual media property based on the data relating to a consumption of an individual media property from members of the target group;
providing a rating group of individuals having a rating score for the individual media property based on conventional media rating methods; and
applying said profitability index to the conventional rating for said rating group to provide a rating score of the rating group for the individual media property.

2. A method according to claim 1 wherein the profitability index is created by calculating a ratio of a consumption of the individual media property by members of the sub group who are projected to be profitable to a consumption of the individual media property by a randomly selected group of consumers.

3. A method according to claim 1 further including the step of filtering the members of the target group for consumer profitability.

4. A method according to claim 3 wherein the filtering of the members of the target group is carried out by administering a questionnaire.

5. A method according to claim 4 wherein the data pertaining to the members of the target group is behavioural data.

6. A method according to claim 5 wherein the behavioural data of members of the target group includes data relating to entertainment consumption of the members of the target group.

7. A method according to claim 1 wherein the individual media property is selected from the group consisting of television shows, movies, radio programs, internet sites, magazines, newspapers, sporting events, music concerts, billboards, advertising catalogues, advertising flyers.

8. A system for adjusting a rating score of a rating group of consumers for an individual media property, the system comprising:
a database including a group of consumers, the database including data variables for each consumer;
means for selecting from said group, a sub-group of consumers;
means for gathering data pertaining to each member of the sub-group, the data relating to non-database variables of said members, the non-database variables being different than the variables contained in the database;
means for calculating a profitability score in relation to a product or service for each member of the sub-group based on the data;
means for calculating a statistical relationship between the profitability score of members of the sub-group and the variables contained in said database of said members of the sub-group;
means for identifying variables contained in said database that are predictive of consumer profitability based on the strength of the statistical relationship between said variables contained in said database and said profitability score;
means for selecting from said group of consumers a target group of consumers having the variables that are predictive of consumer profitability for the product or service;
means for gathering data relating to a consumption of the individual media property from members of the target group;
means for creating a profitability index in relation to said individual media property based on the data relating to the consumption of an individual media property from members of the target group; and
means for applying said profitability index to a rating group of individuals having a rating score for the individual media property based on conventional media rating methods to provide a rating score of the rating group for the individual media property.

9. A system according to claim 8 wherein the profitability index is created by calculating a ratio of a consumption of the individual media property by members of the sub group who are projected to be profitable to a consumption of the individual media property by a randomly selected group of consumers.

10. A system according to claim 8 further including means for filtering the target group for consumer profitability.

11. A system according to claim 10 wherein the means for filtering of the members of the target group is a questionnaire.

12. A system according to claim 8 wherein the data pertaining to the members of the target group is behavioural data.

13. A system according to claim 12 wherein the behavioural data of members of the target group includes data relating to entertainment consumption of the members of the target group.

14. A system according to claim 8 wherein the individual media property is selected from the group consisting of television shows, movies, radio programs, internet sites, magazines, newspapers, sporting events, music concerts, billboards, advertising catalogues, advertising flyers.
